(19) United States
(12) Patent Application Publication
(10) Pub. No.: US 2006/0013938 A1
(43) Pub. Date: Jan. 19, 2006

(54) Method of cooking meat, fowl, or seafood using oil contained therein, and a plate of chicken prepared using the method

(76) Inventor: Moon Soo Kim, Seoul (KR)

Correspondence Address: LADAS & PARRY LLP, 224 SOUTH MICHIGAN AVENUE, SUITE 1600, CHICAGO, IL, 60604, US

(21) Appl. No.: 11/180,344

(22) Filed: Jul. 13, 2005

(30) Foreign Application Priority Data
Jul. 14, 2004 (KR) 10-2004-0054911

(51) Int. Cl. A23B 4/00

(52) U.S. Cl. 426/641

(57) ABSTRACT

Provided are a method of cooking a raw meat, such as meat, fowl, or seafood, using oil contained therein to lower fat, calory, and cholesterol contents and a plate of chicken prepared using the method, the plate of chicken having low fat, calory, and cholesterol contents. The plate of chicken is a healthy food and has a crispy coating and tender and moist inner flesh, like common fried chicken. The method of cooling a raw meat using oil contained therein includes: cutting the raw meat into pieces of a predetermined size and putting the cut raw meat pieces in a spicy source to primarily age the raw meat pieces for a predetermined time; removing the spicy source from the surface of the primarily aged raw meat pieces and uniformly coating the surface of each of the raw meat pieces with coating powder; maintaining the raw meat pieces coated with the coating powder at an ambient temperature for a predetermined time to secondarily age the raw meat pieces such that the coating powder absorbs moisture in the raw meat pieces and forms a coating powder layer; putting the secondarily aged raw meat pieces in an oven and roasting the raw meat pieces at a temperature of 130˜270° C. for 7˜20 minutes; and further roasting the raw meat pieces at a temperature of 130˜270° C. for 2˜5 minutes while supplying an air flow to the oven.

### CROSS-REFERENCE TO RELATED PATENT APPLICATIONS

This application claims the benefit of Korean Patent Application No. 10-2004-0054911, filed on Jul. 14, 2004, in the Korean Intellectual Property Office, the disclosure of which is incorporated herein in its entirety by reference.

### BACKGROUND OF THE INVENTION

1. Field of the Invention

The present invention relates to a method of cooking meat, etc., and more particularly, to a method of cooking a meat, fowl, or seafood using oil contained therein, and a plate of chicken prepared using the method.

2. Description of the Related Art

In general, chicken can be cooked by, for example, frying in oil, boiling in water, direct roasting on a fire, etc. When frying chicken in cooking oil, the chicken can be coated with a paste or powder or with a paste and then powder. The surface of the fried chicken is crispy due to the powder or paste coated thereon, while the inner flesh part is tender and moist. Therefore, fried chicken has been one of the favorite foods of many people.

However, since chicken is fried in high temperature oil, the fried chicken contains a large amount of oil and is greasy. In addition, due to the repeated use of oil in frying, the oil oxidizes, and cholesterol content increases. Moreover, due to high fat content and high calory content, the risk of diseases, such as obesity, heart disease, geriatric diseases, etc., increases for those who eat fried chicken. Therefore, eating such fried chicken fried directly in oil conflicts with the recently wide-spread health trend of modern people who value a healthy diet. Accordingly, despite a large variety of nutrients in chicken and the excellent taste of fried chicken, many people hesitate to eat fried chicken.

### SUMMARY OF THE INVENTION

The present invention provides a method of cooking raw meat, such as meat, fowl, or fish, using oil contained therein to lower fat, calory, and cholesterol contents. The present invention also provides a plate of chicken prepared using the above method, the plate of chicken having low fat, calory, and cholesterol contents. The plate of chicken according to the present invention is a healthy food and has a crispy coating and tender and moist inner flesh, like common fried chicken.

According to an aspect of the present invention, there is provided a method of cooking a raw meat using oil contained in the raw meat, the method comprising: cutting the raw meat into pieces of a predetermined size and putting the cut raw meat pieces in a spicy source to primarily age the raw meat pieces for a predetermined time; removing the spicy source from the surface of the primarily aged raw meat pieces and uniformly coating the surface of each of the raw meat pieces with coating powder; maintaining the raw meat pieces coated with the coating powder at an ambient temperature for a predetermined time to secondarily age the raw meat pieces such that the coating powder absorbs moisture in the raw meat pieces and forms a coating powder layer; putting the secondarily aged raw meat pieces in an oven and roasting the raw meat pieces at a temperature of 130˜270° C. for 7˜20 minutes; and further roasting the raw meat pieces at a temperature of 130˜270° C. for 2˜5 minutes while supplying an air flow to the oven.

The spicy source may be a marinade containing refined salt, soy source, pepper powder, white sugar, and onion juice as main components, and the primary aging is performed for 24˜48 hours.

The coating powder may be prepared by mixing 76.34˜81.11% by weight of wheat flour, 5.79˜9.54% by weight of corn flour, 5.73˜5.79% by weight of refined salt, 5.21˜5.25% by weight of L-sodium glutamate, 1.16˜1.43% by weight of red pepper powder, 0.58˜0.95 by weight of black pepper powder, and 0.35˜0.76% by weight of garlic powder.

The raw meat may be selected from the group consisting of meats, such as pork, beef, etc., fowls, such as chicken, duck, goose, turkey, etc., and seafoods, such as lobster, shrimp, shellfish, and fishes.

When the raw meat is a high fat content meat, such as pork, the coating powder may further include bread crumbles.

According to another aspect of the present invention, there is provided a plate of chicken prepared using the above-described method.

### DETAILED DESCRIPTION OF THE INVENTION

Hereinafter, embodiments of the present invention will be described in detail.

A cooking method according to the present invention includes two aging processes performed under different conditions and two roasting processes.

In particular, a raw meat is cut into pieces, each having an average diameter of 4˜10 cm and a weight of 70˜150 g and put in a spicy source for primary aging. The spicy source is a marinade containing refined salt, soy source, pepper powder, white sugar, and onion juice as main components. The aging time may be in a range of 24˜48 hours. The spices soak into the raw meat through the aging process.

Next, the surface of each of the raw meat pieces is coated with coating powder. When it is necessary to relieve the salty taste of the meat, the spicy source can be removed from the surface of the raw meat pieces before it is coated with coating powder. The coating powder is prepared by adding seasonings, such as refined salt, monosodium L-glutamate, red pepper powder, black pepper powder, garlic powder, etc., into wheat flour or corn flour, which are main components. An appropriate mixing ratio of seasonings in the coating powder is shown in Table 1. An optimal mixing ratio of seasonings in coating powder determined through several times of test cooking is shown in Table 2. A hot seasoning may be further added to emphasize the hot taste.

TABLE 1

| | Appropriate ratio |
|---|---|
| Ingredient | (% by weight) |
| Wheat flour | 76.34˜81.11 |
| Corn flour | 5.79˜9.54 |
| Refined salt | 5.73˜5.79 |
| Monosodium L-glutamate | 5.21˜5.25 |
| Red pepper powder | 1.16˜1.43 |
| Black pepper powder | 0.58˜0.95 |
| Garlic powder | 0.35˜0.76 |

TABLE 2

| | Optimal ratio |
|---|---|
| Ingredient | (% by weight) |
| Wheat flour | 78.95 |
| Corn flour | 7.37 |
| Refined salt | 5.79 |
| Monosodium L-glutamate | 5.26 |
| Red pepper powder | 1.26 |
| Black pepper powder | 0.84 |
| Garlic powder | 0.53 |

Next, the raw meat pieces coated with the coating powder is subjected to secondary aging for a predetermined time to allow the coating powder on the surface of the raw meat to absorb moisture in the raw meat and form a coating powder layer. In this secondary aging process, the raw meat pieces on which the coating powder has been coated are maintained in a dark refrigeration space at a temperature of −2.0˜10.0° C. for 1˜2 hours.

Alternatively, if necessary to cook quickly, instead of waiting for the coating powder layer to be formed by absorbing moisture in the raw meat, the coating power layer can be formed by spraying water on the coating power of the surface of the raw meat. However, for more crispy taste of the surface of the meat prepared according to present invention, it is better to wait for the coating powder layer to be formed by absorbing moisture in the raw meat through the secondary aging process.

Next, the secondarily aged raw meat pieces are roasted in an oven in a closed state at a temperature of 130˜270° C. for 7˜20 minutes. Any type of cooking device, such as a gas oven, an electric oven, etc., can be used provided that it has a closed space for heating. However, cooking devices using radiation heat or convection heat are preferred to cooking devices using heat conduction, like frying fans. In the cooking method according to the present invention, cooking devices using radiation heat or convection heat are suitable to uniformly heat the aged raw meat pieces of a predetermined size.

Next, the raw meat pieces are further roasted at a temperature of 130˜270° C. for 2˜5 minutes while supplying an air flow to the oven. In this process, air is flowed into the oven to evaporate moisture from the surface of the coating powder layer of the meat and exhaust the moisture out of the oven. This process facilitates the evaporation of moisture from the surface of the meat.

If air is flowed throughout the entire roasting operation, i.e., from the beginning to the end of the roasting operation, or if the duration of roasting the meat while supplying an air flow is longer than 5 minutes, too much moisture in the meat is evaporated and the meat texture becomes too tough or chewy. If the duration of roasting the meat while supplying an air flow is shorter than 2 minutes, a proper amount of moisture cannot be evaporated from the coating powder layer and the roasted meat is not crispy. The roasting time ranging from 2˜5 minutes can be varied according to the water content of the raw meat.

The surface of the meat roasted through the above-described processes looks very similar to common fried chicken. In addition, the surface of the roasted meat is crispy while the inner flesh is tender and moist.

Although the surface of the meat cooked according to the present invention looks very similar to common fried chicken, the meat cooked according to the present invention has very different composition from the common fried chicken. In particular, since the coating powder layer on the meat is fried by oil contained in the meat through two roasting processes, its fat and cholesterol contents are markedly lower than those of common fried chicken, which is fried in cooking oil. In addition, since the oil in the meat comes out, the inner flesh becomes non-greasy, soft, and less tough.

In conventional methods of cooking by frying, due to the repeated use of frying oil and the oxidization of the oil, cholesterol content increases. In addition, it is highly likely that foreign substance is incorporated into the oil during storage, and small fragments of previously fried foods remain, raising a hygienic problem. However, in the cooking method according to the present invention, such problems do not arise, and low fat, cholesterol, and calory food can be hygienically cooked.

The two roasting processes in the cooking method according to the present invention may be performed in reverse order. In other words, the roasting process performed while supplying an air flow can be performed first. However, to accelerate the evaporation of moisture to obtain cooked meat with a crispy surface coating, it is preferable to perform the roasting process while supplying an air flow secondly.

Any kind of raw meat can be cooked using the above-described cooking method according to the present invention. Examples of raw meat that can be cooked according to the present invention include: meats, such as pork, beef, etc.; fowls, such as chicken, duck, goose, turkey, etc.; seafoods, such as lobster, shrimp, shellfish, fishes, etc. For a high fat content raw meat, such as pork, bread crumbles may be added to the coating powder such that a larger amount of the oily component in the raw meat can be absorbed. As a result, a less greasy, tender, and moist cooked meat with a crispy coating can be obtained.

As described above, in a cooking method according to the present invention, instead of frying a raw meat in boil, after coating the raw meat with a coating powder layer, the raw meat is roasted using oil contained in the raw meat while supplying an air flow for a predetermined duration to evaporate moisture in the meat and increase crispiness of the surface of the meat. The obtained cooked meat has low fat content and is not greasy. In addition, the surface coating of the cooked meat is crispy while the inner flesh thereof is tender and moist.

In a nutritional aspect, using the cooking method according to the present invention, which does not involve frying in oil, low calory, fat, and cholesterol foods can be cooked, which complies with the currently spread healthy diet trend.

In particular, when the cooking method according to the present invention is used to cook chicken, low calory, fat, and cholesterol, healthy cooked chicken, which is very similar to popular fried chicken, can be obtained.

According to the present invention, a plate of chicken that has low Trans fatty acid content and is good for health can be prepared. Trans fatty acids in diet, which are generated as a result of partial hydrogenation of vegetable oils, have been implicated to cause or exacerbate most modern diseases, including heart disease, cancer, diabetes, obesity, immune dysfunction, and bone loss. The major form of Trans fatty acid included in milk, dairy products, meat etc. is Vaccenic acid (trans-11, 18:1). Table 3 shows the contents of Vaccenic acid (trans-11, 18:1) in the skin of chicken prepared to be served to a customer. The content of Vaccenic acid (trans-11, 18:1) in the skin of the plate of chicken prepared according to the method of present invention was about 4.25%. However, in the case of Comparative Example 1 (fried chicken cooked by frying in oil, Company A), the content of Vaccenic acid (trans-11, 18:1) was about 12.94%. In the case of Comparative Example 2 (fried chicken cooked by frying in oil, Company B), the content of Vaccenic acid (trans-11, 18:1) was about 6.12%.

TABLE 3

| | | Comparative | Comparative |
|---|---|---|---|
| Fatty acid | Present invention | Example 1 | Example 2 |
| Vaccenic acid | 4.25% | 12.94% | 6.12% |
| (trans-11, 18:1) | | | |

While the present invention has been particularly shown and described with reference to embodiments thereof, the embodiments are for only descriptive purposes and are not intended to limit the scope of the invention. The scope of the invention is defined only by the appended claims. It will be understood by those of ordinary skill in the art that various changes in form and details may be made therein without departing from the spirit and scope of the present invention as defined by the following claims.

What is claimed is:

1. A method of cooking a raw meat using oil contained in the raw meat, the method comprising:
cutting the raw meat into pieces of a predetermined size and putting the cut raw meat pieces in a spicy source to primarily age the raw meat pieces for a predetermined time;
removing the spicy source from the surface of the primarily aged raw meat pieces and uniformly coating the surface of each of the raw meat pieces with coating powder;
maintaining the raw meat pieces coated with the coating powder at an ambient temperature for a predetermined time to secondarily age the raw meat pieces such that the coating powder absorbs moisture in the raw meat pieces and forms a coating powder layer;
putting the secondarily aged raw meat pieces in an oven and roasting the raw meat pieces at a temperature of 130˜270° C. for 7˜20 minutes; and
further roasting the raw meat pieces at a temperature of 130˜270° C. for 2˜5 minutes while supplying an air flow to the oven.

2. The method of claim 1, wherein the spicy source is a marinade containing refined salt, soy source, pepper powder, white sugar, and onion juice as main components, and the primary aging is performed for 24˜48 hours.

3. The method of claim 1, wherein the coating powder is prepared by mixing 76.34˜81.11% by weight of wheat flour, 5.79˜9.54% by weight of corn flour, 5.73˜5.79% by weight of refined salt, 5.21˜5.25% by weight of L-sodium glutamate, 1.16˜1.43% by weight of red pepper powder, 0.58˜0.95 by weight of black pepper powder, and 0.35˜0.76% by weight of garlic powder.

4. The method of claim 1, wherein the raw meat is selected from the group consisting of meats, fowls, and seafoods, the meats comprises pork and beef, the fowls comprise chicken, duck, goose, and turkey, and the seafoods comprises lobster, shrimp, shellfish, and fishes.

5. The method of claim 4, wherein when the raw meat is pork or a high fat content meat, the coating powder further includes bread crumbles.

6. A plate of chicken prepared using the method of claim 1.
